(19) United States
(12) Patent Application Publication
(10) Pub. No.: US 2025/0284184 A1
(43) Pub. Date: Sep. 11, 2025

(54) IMAGE PICKUP APPARATUS WITH ACCESSORY SHOE

(71) Applicant: CANON KABUSHIKI KAISHA, Tokyo (JP)

(72) Inventors: YOSAKU ENDO, Kanagawa (JP); KAZUO YAMAMOTO, Tokyo (JP)

(21) Appl. No.: 19/062,631

(22) Filed: Feb. 25, 2025

(30) Foreign Application Priority Data
Mar. 6, 2024 (JP) 2024-033693

(51) Int. Cl. G03B 17/56; G03B 17/02

(52) U.S. Cl. CPC G03B 17/566; G03B 17/02; G03B 17/563

(57) ABSTRACT

Provided is an image pickup apparatus to which an accessory is allowed to be attached while a handle is attached to an accessory shoe of an image pickup apparatus main body, without enlarging the image pickup apparatus main body. An image pickup apparatus includes a main body, a handle detachably attachable to the main body, a first accessory shoe on a top surface of the main body, and a second accessory shoe on a top surface of the handle. The second accessory shoe is attachable with an accessory that is attachable on the first accessory shoe. An electrical contact to be electrically connected to the first accessory shoe is located on a bottom surface of the handle. An electrical connection is located inside the handle to electrically connect the electrical contact and the second accessory shoe.

### BACKGROUND OF THE INVENTION

### Field of the Invention

The present invention relates to image pickup apparatuses equipped with an accessory shoe.

### Description of the Related Art

Some image pickup apparatuses, such as video cameras, are equipped with a handle part to be used for shooting and carrying. In addition, some image pickup apparatuses are configured such that a handle part is attachable to and detachable from a main body of the image pickup apparatus in consideration of storage, handling, and the like.

For example, a known image pickup apparatus has a structure such that a main body of the image pickup apparatus includes an accessory shoe, and a handle part includes a slide sheet metal to be engaged with the accessory shoe of the main body (see, for example, Japanese Laid-Open Patent Publication (kokai) No. 2021-32952). The slide sheet metal and the accessory shoe are engaged and screwed together, so that the handle part is firmly fixed to the main body of the image pickup apparatus.

Some accessory shoes of image pickup apparatus main bodies have an electrical contact. Instead of a handle part, an accessory, such as an audio microphone, can be attached to the image pickup apparatus main body so as to extend functions of an image pickup apparatus by electrically communicating with the image pickup apparatus main body via the electrical contact. When a handle part is attached to such an accessory shoe of an image pickup apparatus main body to which any of various accessories can be attached as described above, no other accessories can be attached to the image pickup apparatus main body. When a plurality of accessory shoes is provided in an image pickup apparatus main body so that other accessories can be attached to the image pickup apparatus main body with a handle part being attached thereto, it increases a size of the image pickup apparatus main body.

### SUMMARY OF THE INVENTION

The present invention provides image pickup apparatuses to which an accessory is allowed to be attached while a handle is attached to an accessory shoe of an image pickup apparatus main body, without enlarging the image pickup apparatus main body.

According to an aspect of the invention, an image pickup apparatus includes a main body, a handle configured to be detachably attachable to the main body, a first accessory shoe on a top surface of the main body, on which an accessory is attachable, and a second accessory shoe on a top surface of the handle, on which an accessory is attachable. The second accessory shoe is attachable with an accessory that is attachable on the first accessory shoe. The image pickup apparatus further includes an electrical contact on a bottom surface of the handle, to be electrically connected to the first accessory shoe, and includes an electrical connection located inside the handle to electrically connect the electrical contact and the second accessory shoe.

According to the present invention, it is possible to attach an accessory to an image pickup apparatus main body while a handle is attached to an accessory shoe of the image pickup apparatus main body, without enlarging the image pickup apparatus main body.

Further features of the present invention will become apparent from the following description of exemplary embodiments with reference to the attached drawings.

### BRIEF DESCRIPTION OF THE DRAWINGS

FIGS. 1A and 1B are external views of an image pickup apparatus according to the present embodiment.

FIGS. 2A and 2B are external views illustrating a handle unit being detached from an image pickup apparatus main body in FIGS. 1A and 1B.

FIGS. 3A and 3B are internal configuration diagrams of the handle unit in FIGS. 1A and 1B.

FIG. 4 is an external view illustrating an external microphone being attached to the image pickup apparatus main body in FIGS. 1A and 1B.

FIG. 5 is an external view illustrating an external microphone being attached to the handle unit fixed to the image pickup apparatus main body in FIGS. 1A and 1B.

FIG. 6 is an external view of a bottom surface of the handle unit in FIGS. 1A and 1B.

FIG. 7 is an external view of a side surface of the handle unit in FIGS. 1A and 1B.

FIGS. 8A and 8B are a perspective views illustrating an internal configuration of the handle unit in FIGS. 1A and 1B.

### DESCRIPTION OF THE EMBODIMENTS

The present invention will now be described in detail below with reference to the accompanying drawings showing embodiments thereof.

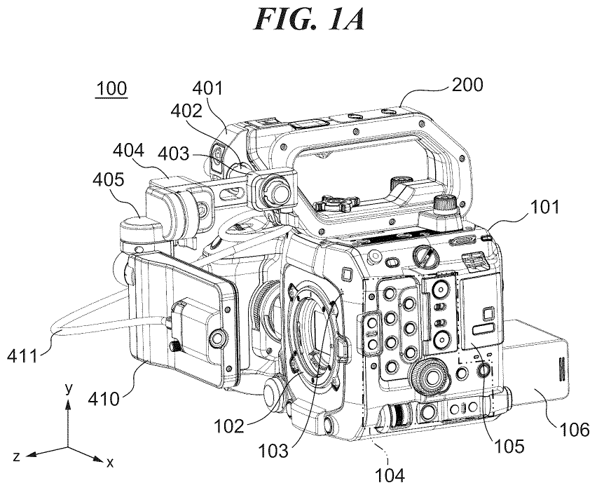

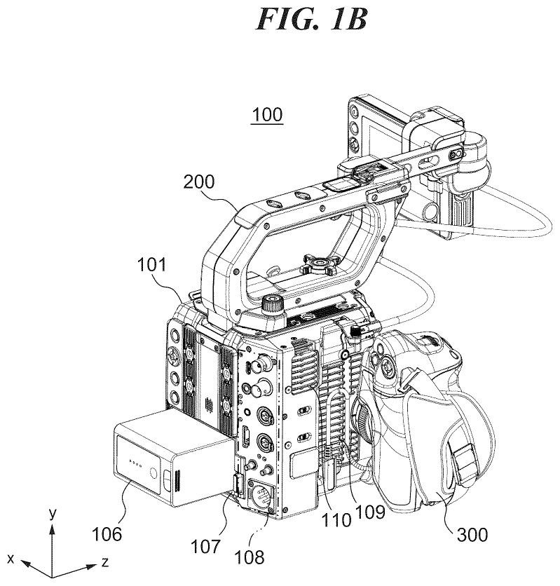

Here, for convenience of description, a coordinate system is defined as illustrated in FIGS. 1A and 1B. The Z axis is defined as a front-rear direction along an optical axis of an image pickup apparatus (a front lens side is defined as a +Z direction), the Y axis is defined as an up-down direction of the image pickup apparatus (a top surface side is defined as a +Y direction), and the X axis is defined as a left-right direction of the image pickup apparatus (a right surface side as viewed from the front is defined as a +X direction). An image pickup apparatus according to the present embodiment is a lens-interchangeable image pickup apparatus, and will be hereinafter referred to simply as an image pickup apparatus.

First, an outline of an image pickup apparatus 100 according to the present embodiment is be described with reference to FIGS. 1A and 1B.

FIGS. 1A and 1B are external views of the image pickup apparatus 100. FIG. 1A is a perspective view of the image pickup apparatus 100 when viewed from the front thereof, and FIG. 1B is a perspective view of the image pickup apparatus 100 when viewed from the back thereof.

As illustrated in FIGS. 1A and 1B, the image pickup apparatus 100 includes an image pickup apparatus main body 101 and a handle unit 200. The image pickup apparatus main body 101 has a hexahedron shape, and one surface of the body is provided with a mount part 102 on which an interchangeable lens unit is mountable and with a built-in microphone part 103 for recording sound.

It should be noted that, a surface of the image pickup apparatus main body 101 on which the mount part 102 and the built-in microphone part 103 are provided is defined as a front surface of the image pickup apparatus main body 101, and a surface of the image pickup apparatus main body 101 opposite to the front surface is defined as a rear surface of the image pickup apparatus main body 101. Furthermore, a side surface on the right of the image pickup apparatus main body 101 as viewed from the front is defined as a right surface of the image pickup apparatus main body 101, and a side surface on the left of the image pickup apparatus main body 101 as viewed from the front is defined as a left surface of the image pickup apparatus main body 101. Furthermore, a surface of the image pickup apparatus main body 101 to which the handle unit 200 is attachable is defined as a top surface of the image pickup apparatus main body 101, and a surface of the image pickup apparatus main body 101 opposite to the top surface is defined as a bottom surface of the image pickup apparatus main body 101.

The right surface of the image pickup apparatus main body 101 is provided with an operation button group 104 that receives an operation of an operator and then causes the image pickup apparatus main body 101 to execute a predetermined operation, and with a recording medium storage lid 105 that covers a storage chamber that stores a recording medium (which is not illustrated).

The rear surface of the image pickup apparatus main body 101 is provided with a battery housing 107 that houses a battery 106 that supplies power to the image pickup apparatus main body 101, and with an input/output terminal group 108 including an external connection terminal and a power terminal.

The left surface of the image pickup apparatus main body 101 is provided with an intake port 109 for drawing low-temperature air into the image pickup apparatus main body 101 by using an internal fan (which is not illustrated) and with an exhaust port 110 for discharging high-temperature air to the outside. In addition, a grip 300 is detachably provided on the left surface of the image pickup apparatus main body 101, which allows an operator to perform various operations while gripping the grip 300.

A handle unit 200 for an operator to hold is detachably provided on the top surface of the image pickup apparatus main body 101. It should be noted that a method for fixing the handle unit 200 to the image pickup apparatus main body 101 will be described later.

A rod fixing part 401 is detachably provided in front of the handle unit 200, and a rod 402 having a circular cross section is inserted through the rod fixing part 401. A slide rail 403 is provided on an end of the rod 402 opposite to the rod fixing part 401, and the rod 402 is inserted through the slide rail 403 in the same manner. A slide base 404 is provided on the slide rail 403 to be slidable. The slide base 404 is provided with a triaxial rotation mechanism 405 capable of rotating in an axial direction parallel to each of the X axis, the Y axis, and the Z axis.

A display panel unit 410 configured to display an image is detachably attached to the other end of the triaxial rotation mechanism 405. The display panel unit 410 is electrically connected to the image pickup apparatus main body 101 via a detachable connection cable 411, and thus video signals and the like are transmitted and received between the display panel unit 410 and the image pickup apparatus main body 101. With such a configuration, the display panel unit 410 can move to a position within its movable range with a high degree of freedom.

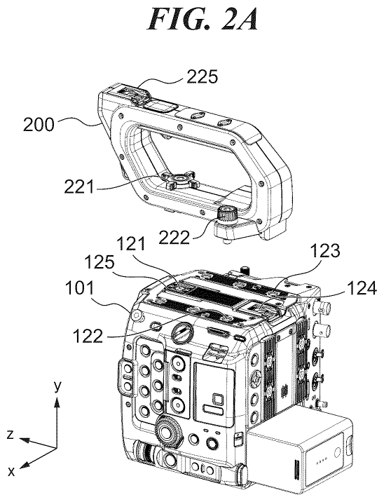

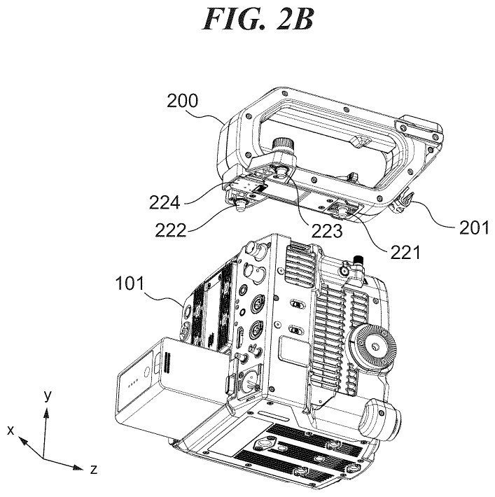

A cable holding part 201 (see FIG. 2B) configured to hold a cable such as the connection cable 411 is provided in the front of the handle unit 200 so that the cable holding part 201 is detachable from the handle unit 200.

Next, how to attach and fix the handle unit 200 to the image pickup apparatus main body 101 is described with reference to FIGS. 2A and 2B.

FIGS. 2A and 2B are external views illustrating the handle unit 200 being detached from the image pickup apparatus main body 101 in FIGS. 1A and 1B. FIG. 2A is a perspective view of the handle unit 200 being detached from the image pickup apparatus main body 101 as viewed from the left of the image pickup apparatus main body 101. FIG. 2B is a perspective view of the handle unit 200 being detached from the image pickup apparatus main body 101 as viewed from the right of the image pickup apparatus 100.

As illustrated in FIG. 2A, the top surface of the image pickup apparatus main body 101 is provided with a first fixing part 121, a second fixing part 122, and a third fixing part 123 to which the handle unit 200 is fixed. On the other hand, as illustrated in FIG. 2B, the bottom surface of the handle unit 200 is provided with a first screw part 221 to be fastened to the first fixing part 121, a second screw part 222 to be fastened to the second fixing part 122, and a third screw part 223 to be fastened to the third fixing part 123. The first screw part 221, the second screw part 222, and the third screw part 223 serve as fixing parts of the handle unit 200.

As illustrated in FIG. 2A, a main body accessory shoe 124 on which an accessory is attachable is provided on the top surface of the image pickup apparatus main body 101. The main body accessory shoe 124 has an electrical contact. On the main body accessory shoe 124, an accessory, such as an external microphone, is attachable, where the accessory extends functions of the image pickup apparatus 100 by electrically communicating with the image pickup apparatus main body 101. On the other hand, as illustrated in FIG. 2B, a handle contact part 224 to be attached to the main body accessory shoe 124 is provided on the bottom surface of the handle unit 200.

When the handle unit 200 is attached to the image pickup apparatus main body 101, the handle unit 200 is slid forward from the rear on the top surface of the image pickup apparatus main body 101, and the first screw part 221, the second screw part 222, and the third screw part 223 are screwed into the first fixing part 121, the second fixing part 122, and the third fixing part 123, respectively, so that the handle unit 200 is fixed to the image pickup apparatus main body 101. In this case, the main body accessory shoe 124 of the image pickup apparatus main body 101 and the handle contact part 224 of the handle unit 200 are electrically connected via an electrical connection structure provided inside the handle unit 200.

Here, in the image pickup apparatus main body 101, the first fixing part 121 and the main body accessory shoe 124 are located substantially on the optical axis of the image pickup apparatus 100 when viewed from above the image pickup apparatus 100. The first fixing part 121 is located in the front (on the side close to the front surface of the image pickup apparatus main body 101) of the top surface of the image pickup apparatus main body 101, and the main body accessory shoe 124 is located in the rear (on the side close to the rear surface of the image pickup apparatus main body 101) of the top surface of the image pickup apparatus main body 101. In contrast, in the handle unit 200, the first screw part 221 and the handle contact part 224 are located substantially on the optical axis when the image pickup apparatus 100 is viewed from below. The first screw part 221 is located in the front (on the side close to the front surface of the image pickup apparatus main body 101) of the bottom surface of the handle unit 200, and the handle contact part 224 is located in the rear (on the side close to the rear surface of the image pickup apparatus main body 101) of the bottom surface of the handle unit 200.

A handle accessory shoe 225 is provided on the top surface of the handle unit 200. The handle accessory shoe 225 has the same shape as the main body accessory shoe 124, and has an electrical contact similarly to the main body accessory shoe 124. Thus, the handle accessory shoe 225 is attachable with an accessory such as the above-described external microphone that is attachable on the main body accessory shoe 124 of the image pickup apparatus main body 101.

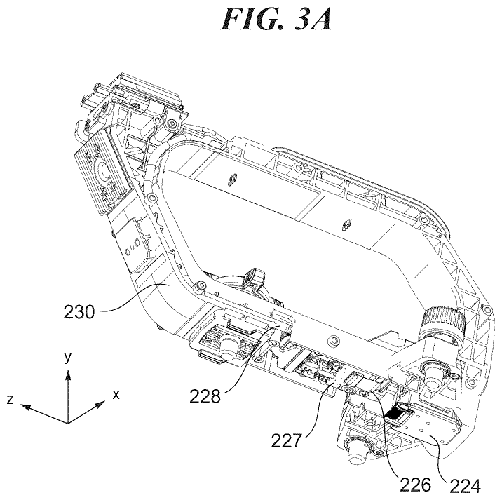

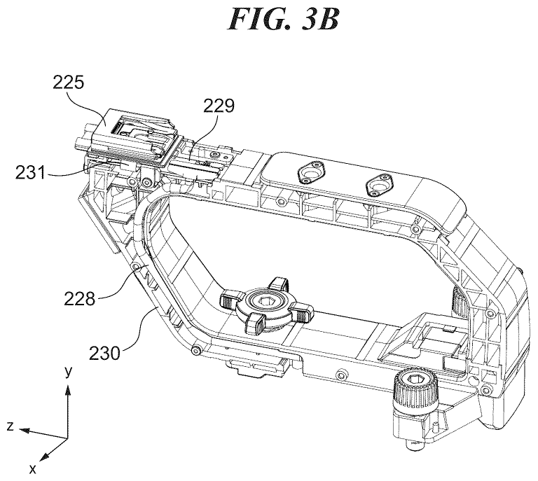

Next, an electrical connection structure inside the handle unit 200 is described. FIGS. 3A and 3B are internal configuration diagrams of the handle unit 200 in FIGS. 1A and 1B. It should be noted that FIGS. 3A and 3B illustrate the handle unit 200 with the exterior cover removed. FIG. 3A is a perspective view of the handle unit 200 as viewed from the bottom surface side thereof. FIG. 3B is a perspective view of the handle unit 200 as viewed from the top surface side thereof.

In the handle unit 200, the handle contact part 224 is electrically connected to a first circuit board 227 via a first electrical connection component 226, as illustrated in FIG. 3A. In the present embodiment, the first electrical connection component 226 is, for example, a flexible printed circuit board, and is routed in a space inside the handle unit 200, which is narrow in a thickness direction of the first electrical connection component 226.

In the handle unit 200, the first circuit board 227 is electrically connected to a second circuit board 229 via a second electrical connection component 228, as illustrated in FIG. 3B. The second electrical connection component 228 is, for example, an internal wiring wire, and is routed from the lower portion to the upper portion of the handle unit 200 through a gap of a handle frame 230 inside the handle unit 200. The second circuit board 229 is electrically connected to the handle accessory shoe 225 via a third electrical connection component 231. The third electrical connection component 231 is, for example, a flexible printed circuit board, and is routed in a narrow space. With the above configuration, the handle contact part 224 of the handle unit 200 and the handle accessory shoe 225 are electrically communicatively connected via a circuit board and/or an electrical connection component inside the handle unit 200.

Further, the first circuit board 227 is arranged near the handle contact part 224, and the second circuit board 229 is arranged near the handle accessory shoe 225. As will be described later, the handle unit 200 is configured to transmit signals for communicating electrically with the main body accessory shoe 124. For this reason, a correction circuit including a buffer that corrects signals for electrical communication is provided on each of the first circuit board 227 arranged near the handle contact part 224 connected to the image pickup apparatus main body 101 and the second circuit board 229 arranged near the handle accessory shoe 225 connected to an accessory.

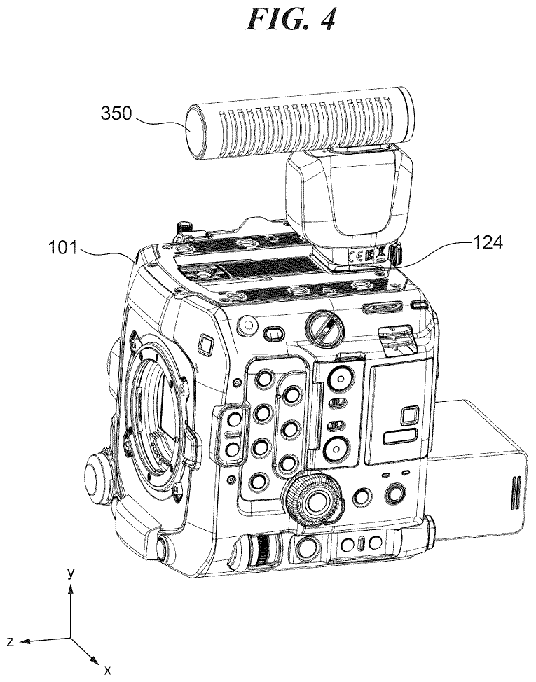

FIG. 4 is an external view illustrating an external microphone 350 being attached to the image pickup apparatus main body 101 in FIGS. 1A and 1B. For example, as illustrated in FIG. 4, the external microphone 350, which is an external accessory, is attached on the main body accessory shoe 124 in the rear of the top surface of the image pickup apparatus main body 101. The external microphone 350 becomes usable by being electrically connected to the image pickup apparatus main body 101 through connection of an electric wiring component (which is not illustrated). The external microphone 350 has functions such as switching of directivity and digital signal processing, and is configured to record sound with higher quality than that of the built-in microphone part 103 included in the image pickup apparatus main body 101. That is, the audio functions of the image pickup apparatus main body 101 are extended by attaching the external microphone 350 to the image pickup apparatus main body 101. Furthermore, as described above, by arranging the main body accessory shoe 124 in the rear of the image pickup apparatus main body 101, the external microphone 350 can be easily attached from the rear of the image pickup apparatus main body 101.

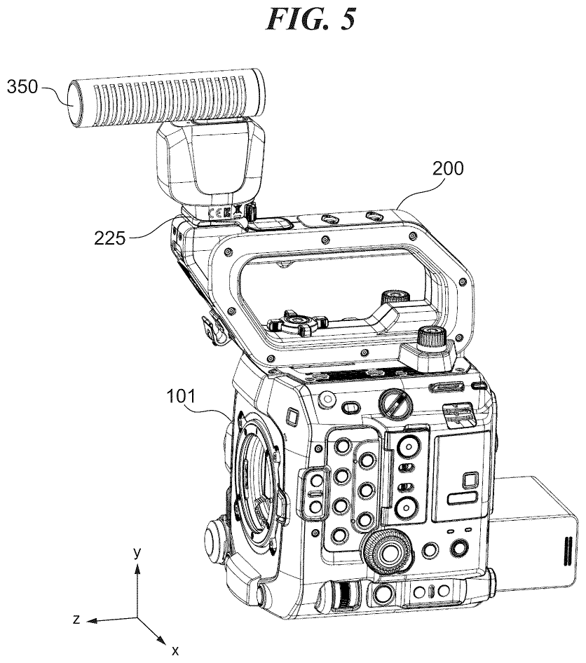

FIG. 5 is an external view illustrating the external microphone 350 being attached to the handle unit 200 fixed to the image pickup apparatus main body 101 in FIGS. 1A and 1B. As described with reference to FIGS. 2A, 2B, 3A, and 3B, when the handle unit 200 is attached to the image pickup apparatus main body 101, the main body accessory shoe 124 of the image pickup apparatus main body 101 and the handle contact part 224 of the handle unit 200 are electrically connected. In this state, the handle unit 200 is fixed to the image pickup apparatus main body 101 by tightening each of the first screw part 221, the second screw part 222, and the third screw part 223.

The external microphone 350, which is an external accessory, is attached on the handle accessory shoe 225 in the front of the top surface of the handle unit 200. In this state, the external microphone 350 is connected to the handle contact part 224 via the handle accessory shoe 225 and an electrical connection component inside the handle unit 200, and is further electrically communicatively connected to the main body accessory shoe 124 of the image pickup apparatus main body 101.

As a result, the external microphone 350 becomes usable by electrically communicating with the image pickup apparatus main body 101. That is, an accessory that is usable by being attached to the image pickup apparatus main body 101 also becomes usable even in a state in which the handle unit 200 is attached to the image pickup apparatus main body 101. In other words, a signal for electrical communication between the accessory and the image pickup apparatus main body 101 is transmitted via the electrical connection component provided in the handle unit 200, which allows the accessory to be attached to and used at a position different from the image pickup apparatus main body 101. Therefore, an accessory can be used along with the image pickup apparatus 100 to suite various use modes of the image pickup apparatus 100 without providing a new accessory shoe on the image pickup apparatus main body 101. As a result, it is possible to improve the convenience of the image pickup apparatus 100 at the time of shooting without increasing the size of the image pickup apparatus main body 101. For example, when it is desired to attach the external microphone 350 at a position higher than the image pickup apparatus main body 101 or on the subject side, the external microphone 350 can be used by being attached on the handle accessory shoe 225 while the handle unit 200 is attached to the image pickup apparatus main body 101.

In addition, as described above, the handle accessory shoe 225 is arranged in the front of the top surface of the handle unit 200, so that an operator can hold the handle unit 200 without hindrance even in a state in which an accessory is attached on the handle accessory shoe 225.

It should be noted that, in the present embodiment, the configuration has been described in which each of the image pickup apparatus main body 101 and the handle unit 200 includes one accessory shoe, but the configuration is not limited to this. For example, the handle unit 200 may include a plurality of accessory shoes, and the accessory shoes may have the same specification or different specifications. Further, the accessory shoes may be configured to be used simultaneously or may be configured to be used alternately rather than simultaneously.

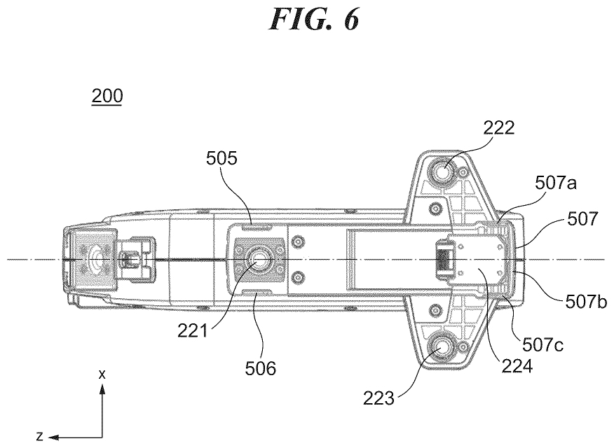

Next, a configuration of the bottom surface of the handle unit 200 is described with reference to FIG. 6. FIG. 6 is an external view of the bottom surface of the handle unit 200 in FIGS. 1A and 1B.

As illustrated in FIG. 6, the bottom surface of the handle unit 200 is provided with a plurality of ribs (at least two protrusions) extending substantially parallel to the top surface of the image pickup apparatus main body 101, specifically, a first protrusion 505, a second protrusion 506, and a third protrusion 507. The first protrusion 505 is located near the first screw part 221. In the present embodiment, the first protrusion 505 extends in the optical axis direction with a constant width, facing the first screw part 221, and has a protrusion shape protruding in the −Y direction (the direction toward the image pickup apparatus main body 101) from the bottom surface of the handle unit 200.

Similarly to the first protrusion 505, the second protrusion 506 is located near the first screw part 221, and faces the first protrusion 505 across the optical axis and the first screw part 221. The second protrusion 506 has substantially the same shape as the first protrusion 505. The first protrusion 505 and the second protrusion 506 are substantially parallel.

The third protrusion 507 is located at the approximate center of the second screw part 222 and the third screw part 223, and has a protrusion shape protruding in the −Y direction (the direction toward the image pickup apparatus main body 101) from the bottom surface of the handle unit 200. The third protrusion 507 is formed to surround three sides of the back of the handle contact part 224 and the left and right of the handle contact part 224, and has a substantially U-shaped protrusion shape in which a left part 507a, a rear part 507b, and a right part 507c are connected. In addition, the third protrusion 507 protrudes more than the handle contact part 224 when viewed from the side surface side of the handle unit 200.

It should be noted that a rib part of the third protrusion 507 is not located in front of the handle contact part 224. This provides an opening for the handle unit 200 to slide from the rear surface side toward the front surface side of the image pickup apparatus main body 101 and to be connected to the image pickup apparatus main body 101 via the handle contact part 224.

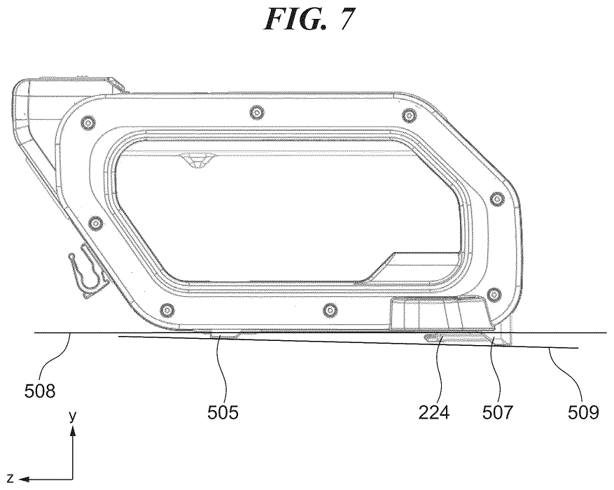

As illustrated in FIG. 6, on the bottom surface of the handle unit 200, the first screw part 221 is provided in the front of the handle unit 200, and the second screw part 222 and the third screw part 223 are provided in the rear of the handle unit 200. The first screw part 221 is located substantially on the optical axis. The second screw part 222 and the third screw part 223 are located at positions facing each other across the optical axis when viewed from the bottom surface side of the handle unit 200. The handle contact part 224 is disposed substantially on the optical axis. That is, the handle contact part 224 is located at an intermediate position between the second screw part 222 and the third screw part 223. The handle contact part 224 is located on the bottom surface of the handle unit 200, at a position overlapping at least a part of a region formed by connecting the first screw part 221, the second screw part 222, and the third screw part 223. With the arrangement, the handle contact part 224 lies within in a region of the bottom surface of the handle unit 200 that is firmly fixed to the image pickup apparatus main body 101 by the three fixing parts, and this improves the connection reliability between the main body accessory shoe 124 of the image pickup apparatus main body 101 and the handle contact part 224 of the handle unit 200. Next, a relationship between the three protrusions provided in the handle unit 200 and the handle contact part 224 is described with reference to FIG. 7.

FIG. 7 is an external view of the side surface of the handle unit 200 in FIGS. 1A and 1B. As illustrated in FIG. 7, the third protrusion 507 protrudes more than (further below) the handle contact part 224 when viewed from the side surface side of the handle unit 200.

A plane 508 indicates a plane formed by connecting the root portions of the first protrusion 505, the second protrusion 506, and the third protrusion 507. A plane 509 indicates a plane formed by connecting the top portions of the first protrusion 505, the second protrusion 506, and the third protrusion 507, that is, a plane formed by connecting the outermost portions of the bottom surface of the handle unit 200. As illustrated in FIG. 7, the entire handle contact part 224 is positioned closer to the handle unit 200 than the plane 509. Therefore, when the handle unit 200 alone is placed on a floor, a desk, or the like or falls on the ground or the like, the three ribs (the first protrusion 505, the second protrusion 506, and the third protrusion 507) hit the ground or the like before the handle contact part 224. This prevents the handle contact part 224 from being broken. It should be noted that the arrangement of a plurality of protrusions and the handle contact part 224 is not particularly limited. It is sufficient if one of the protrusions is located in the front of the handle unit 200, another is located in the rear of the handle unit 200 and near the handle contact part 224, and when the handle unit 200 is viewed from the side surface side of the handle unit 200, the entire handle contact part 224 is located closer to the handle unit 200 than a line connecting the most protruding point of one protrusion and the most protruding point of another protrusion.

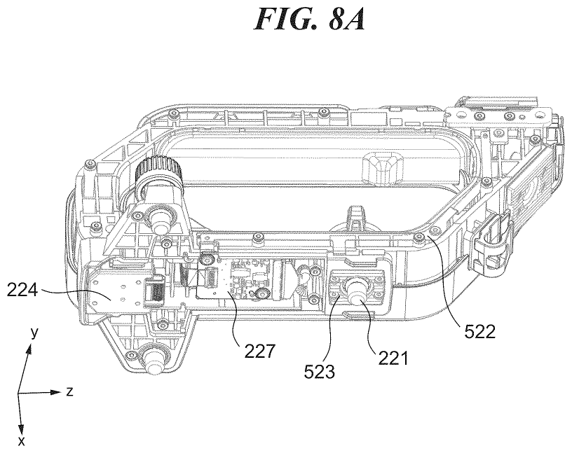

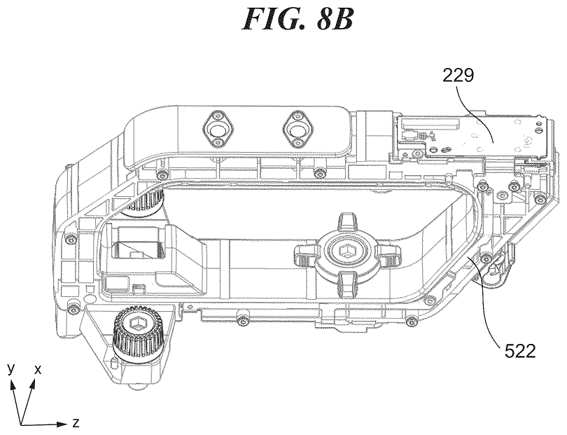

Next, connection between various circuit boards and the ground (GND) is described with reference to FIGS. 8A and 8B.

FIGS. 8A and 8B are perspective views illustrating an internal configuration of the handle unit 200 in FIGS. 1A and 1B. It should be noted that FIGS. 8A and 8B illustrate the handle unit 200 with the exterior cover removed. FIG. 8A is a perspective view of the handle unit 200 as viewed from the bottom surface side, and FIG. 8B is a perspective view of the handle unit 200 as viewed from the top surface side.

As illustrated in FIG. 8A, the handle contact part 224 and the first circuit board 227 are arranged on the bottom surface of the handle unit 200, and as illustrated in FIG. 8B, the second circuit board 229 is arranged on the top surface of the handle unit 200. A sheet metal 522 (conductive member) made of a metal material such as stainless steel is disposed on both side surfaces of the handle unit 200.

Each of the second circuit board 229 and the first circuit board 227 has a portion where a copper foil is exposed, and these circuit boards are electrically connected to the sheet metal 522 serving as a ground due to contact between each copper foil portion and the sheet metal 522.

As illustrated in FIG. 8A, a handle engagement component 523 to be engaged with the image pickup apparatus main body 101 is arranged around the first screw part 221 on the bottom surface of the handle unit 200. As illustrated in FIG. 2A, a main body engagement component 125 to be engaged with the handle unit 200 is arranged around the first fixing part 121 on the top surface of the image pickup apparatus main body 101. Each of the handle engagement component 523 and the main body engagement component 125 is formed of a metal component. When the handle unit 200 is fixed to the image pickup apparatus main body 101, the main body engagement component 125 and the handle engagement component 523 are engaged with each other, so that the image pickup apparatus main body 101 and the handle unit 200 can be firmly fixed.

The second circuit board 229, the first circuit board 227, and the handle engagement component 523 are connected to the sheet metal 522 serving as a ground. When the handle unit 200 is fixed to the image pickup apparatus main body 101, the main body engagement component 125 and the handle engagement component 523 are connected. With such a configuration, a reference potential of signals in a case where the image pickup apparatus main body 101 and the handle unit 200 are electrically communicatively connected is stabilized, and thus radiation noise can be reduced. Further, resistance to external noise can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, for an electrical connection structure inside the handle unit 200, the handle contact part 224 and the handle accessory shoe 225 may be directly connected without interposing a circuit board.

This application claims the benefit of Japanese Patent Application No. 2024-033693, filed Mar. 6, 2024, which is hereby incorporated by reference wherein in its entirety.

What is claimed is:

1. An image pickup apparatus comprising:
a main body;
a handle configured to be detachably attachable to the main body;
a first accessory shoe on a top surface of the main body, on which an accessory is attachable;
a second accessory shoe on a top surface of the handle, on which an accessory is attachable, wherein the second accessory shoe is attachable with an accessory that is attachable on the first accessory shoe;
an electrical contact on a bottom surface of the handle, to be electrically connected to the first accessory shoe; and
an electrical connection located inside the handle to electrically connect the electrical contact and the second accessory shoe.

2. The image pickup apparatus according to claim 1,
wherein the first accessory shoe is located in a rear of a top surface of the main body, and
the electrical contact is located in a rear of the bottom surface of the handle.

3. The image pickup apparatus according to claim 1,
wherein the second accessory shoe is located in a front of the top surface of the handle.

4. The image pickup apparatus according to claim 1, further comprising a cable holder provided in a front of the handle so as to be detachable from the handle, the cable holder being configured to hold a cable of an accessory.

5. The image pickup apparatus according to claim 1,
wherein the handle includes at least two protrusions protruding from the bottom surface of the handle toward the main body and extending substantially parallel to the top surface of the main body,
a first protrusion of the at least two protrusions is located in a front of the handle,
a second protrusion of the at least two protrusions is located in a rear of the handle and near the electrical contact, and
when the handle is viewed from a side surface side of the handle, the entire electrical contact is located closer to the handle than a line connecting a most protruding point of the first protrusion and a most protruding point of the second protrusion.

6. The image pickup apparatus according to claim 1,
wherein a first fixing part, a second fixing part, and a third fixing part are arranged on the bottom surface of the handle, the first fixing part is located on an optical axis of the image pickup apparatus in a front of the handle, and the second fixing part and the third fixing part are located at positions facing each other across the optical axis in a rear of the handle, and
wherein the electrical contact is located on the bottom surface of the handle, at a position overlapping at least a part of a region formed by connecting the first fixing part, the second fixing part, and the third fixing part.

7. The image pickup apparatus according to claim 6,
wherein the handle includes a first protrusion, a second protrusion, and a third protrusion protruding from the bottom surface of the handle toward the main body and extending substantially parallel to the top surface of the main body,
the first protrusion and the second protrusion are located at positions facing each other across the first fixing part, and
the third protrusion extends to surround a back of the electrical contact and both sides of the electrical contact, and protrudes more than the electrical contact when viewed from a side surface side of the handle.

8. The image pickup apparatus according to claim 1, further comprising:
a first board on the bottom surface of the handle;
a handle engagement component on the bottom surface of the handle, to be engaged with the main body;
a second board on the top surface of the handle;
a conductive member connecting the first board, the second board, and the handle engagement component; and
a main body engagement component on the top surface of the main body, to be engaged with the handle,
wherein the handle engagement component and the main body engagement component are to be connected.
